(19) United States
(12) Patent Application Publication
(10) Pub. No.: US 2015/0324489 A1
(43) Pub. Date: Nov. 12, 2015

(54) DESIGN CHANGE PROCESS MANAGEMENT DEVICE AND METHOD

(71) Applicant: Makoto ONODERA, Tokyo (JP)

(72) Inventor: Makoto ONODERA, Tokyo (JP)

(73) Assignee: HITACHI, LTD., Tokyo (JP)

(21) Appl. No.: 14/411,986

(22) PCT Filed: Sep. 6, 2012
(86) PCT No.: PCT/JP2012/072815

§ 371 Date: Dec. 30, 2014

(51) Int. Cl. G06F 17/50

(52) U.S. Cl. CPC G06F 17/50

(57) ABSTRACT

There is provided a design change process management device including: a design change metadata generation unit that extracts design parameters from design information such as CAD data and simulation data and registers the extracted design parameters as first design change metadata; a design change metadata archive in which the first design change metadata is registered; a design change process generation unit that generates first design change process data from differences between the registered first design change metadata and second design change metadata already registered in the design change metadata archive; a design change process archive in which the generated first design change process data is registered; and a similar design change search unit that searches the design change process archive for second design change process data similar to a design change designated by an operator.

### TECHNICAL FIELD

The present invention relates to a device and a method for supporting product design. More particularly, the invention relates to a device and a method for searching and visualizing the process of design changes being made.

### BACKGROUND ART

As a method for managing product information in unified fashion, there exists a PLM (Product Lifecycle Management) system that integrally manages diverse kinds of information spanning the entire lifecycle of a product ranging from product design to manufacturing to marketing to maintenance. The PLM system manages CAD (Computer Aided Design) data about the individual components making up the product and a hierarchical structure of these components in association with the design specifications, simulation results, and experimental data related to the components. In recent years, there have been developed methods for managing the product information about the entire product lifecycle including manufacturing information, procurement information, and repair and maintenance information.

Generally, the information that has undergone reviews of prototypes, end products, etc., or the information otherwise reviewed is registered as the data to be managed by the PLM system. This is intended to secure the reliability of the information registered with the PLM system. On the other hand, it is important to manage the process of design changes and their bases. For example, when a given component is subject to design change in accordance with the requirement specification, it is necessary to know the process and bases on which the original component was shaped and its material was selected, so that new design ideas may be created and verified rapidly. Without such knowledge, there is a possibility that proposals discarded during the design process of the original component may be needlessly brought up again or that a new proposal may be left unnoticed which might have been inspired given the knowledge of the past design proposals. In the past, the person in charge of designing the original component often remained in the same department or stationed at the same site. Thus the problems regarding the component of interest could be resolved simply through hearings or like measures. Today, however, with design and manufacturing venues deployed globally, such design changes are difficult to deal with due to the problems of distance, time difference and language.

As stated above, it is important to manage the process of design changes and their bases. But it is not realistic to manage the history of all information about the process of design changes. The CAD data and simulation result data typically require a disk space of 100 MB to 1 TB per case. Thus it is difficult to apply the existing management scheme to a design task that would involve evaluating design proposals of 10 to 1000 cases per product amounting to enormous disk space requirements. It is also difficult to share such huge quantities of data between global sites due to constraints on network transmission rates.

On existing technique for managing the process of design changes and their bases is a change effect prediction method for use with a change effect prediction device equipped with a change result database that has history information about past changes registered therein (Patent Literature 1). There is also a method for registering layout and specification data about piping in a predetermined common database every time the piping is revised by CAD, so that the differences between the revisions may be easily discovered and extracted (Patent Literature 2). Further, there is a method for storing related information about design changes and, based on the design history acquired, displaying the process of model design in a tree structure (Patent Literature 3).

### PRIOR ART LITERATURE

### Patent Literature

Patent Literature 1 JP-2012-14308-A
Patent Literature 2 JP-2008-257510-A
Patent Literature 3 JP-05(1993)-081355-A

### SUMMARY OF THE INVENTION

### Problems to be Solved by the Invention

However, the above-mentioned existing techniques have the following problems:

One problem with the technique disclosed in Patent Literature 1 is that the user must deliberately input change details to the change result database. Another problem is that it is impossible to grasp interactive effects between continuous design changes. For example, suppose that raising a dimension A improved stiffness but also increased load. In that case, a dimension B may later be reduced so that stiffness may still be improved without causing an increase in load. It is impossible to grasp the effects of design changes resulting from such a series of past operations. That is, the process (history) of design changes is not taken into consideration.

One trouble with the method disclosed in Patent Literature 2 is that although the differences between the revisions can be extracted, there is no consideration for the process of the design changes involved and for the intentions that brought about the changes. Another problem is that it is impossible to search for information about the differences. That is, it is difficult to examine whether similar design changes were made in the past.

One trouble with the method disclosed in Patent Literature 3 is that there is no means for searching or displaying similar design change results. It follows that it is impossible to examine whether or not any design change idea that the user has come up with was already implemented, or whether any similar ideas were proposed in the past. Another trouble is that it is impossible to accumulate or manage the design processes involving repeatedly changing the same parameter. For example, it is impossible to accumulate design processes in which raising the dimension A improved stiffness but also increased load, so that the dimension A would be subsequently made smaller to take a trade-off between stiffness and load into consideration. A further problem is that with no simulation data addressed, it is impossible to manage the grounds for design changes based on simulation results.

The present invention thus provides a design change process management device that accumulates and manages design change process results and the bases for the design changes involved, searches the results for a similar design change process, and displays the searched-for design process.

### Means for Solving the Problems

The design change process management device disclosed by this invention includes: a design change metadata generation unit that extracts design parameters from design information such as CAD data and simulation data and registers the extracted design parameters as first design change metadata; a design change metadata archive in which the first design change metadata is registered; a design change process generation unit that generates first design change process data from differences between the registered first design change metadata and second design change metadata already registered in the design change metadata archive; a design change process archive in which the generated first design change process data is registered; and a similar design change search unit that searches the design change process archive for second design change process data similar to a design change designated by an operator, the similar design change search unit further displaying the searched-for second design change process data on an input/output device.

In a preferred embodiment of the design change process management device, the first design change metadata may at least include a data type, a data name, and a value.

In another preferred embodiment of the design change process management device, the design change process generation unit may compare the first design change metadata with the existing second design change metadata registered in the design change metadata archive, search the second design change metadata for existing third design change metadata having the smallest of the differences resulting from the comparison, search the design change process archive for third design change process data including the third design change metadata, and add the first design change metadata as a child node of the third design change metadata in the searched-for third design change process data.

In another preferred embodiment of the design change process management device, the similar design change search unit may compare the first design change metadata with the existing second design change metadata registered in the design change metadata archive, search the second design change metadata for third design change metadata having the smallest of the differences resulting from the comparison, search the design change process archive for third design change process data including the third design change metadata, and display the searched-for third design change process data on the input/output device.

### Effect of the Invention

It is possible to accumulate and manage design change process results and the bases for the design changes involved, search the results for a similar design change process, and display the searched-for design process.

### BRIEF DESCRIPTION OF THE DRAWINGS

FIG. 1 is a typical block diagram of this design change process management device.

FIG. 2 indicates typical design change metadata.

FIG. 3 lists typical design change process data.

FIG. 4 shows a specific example obtained by use of this device.

FIG. 5 shows another specific example obtained by use of this device.

### MODE FOR CARRYING OUT THE INVENTION

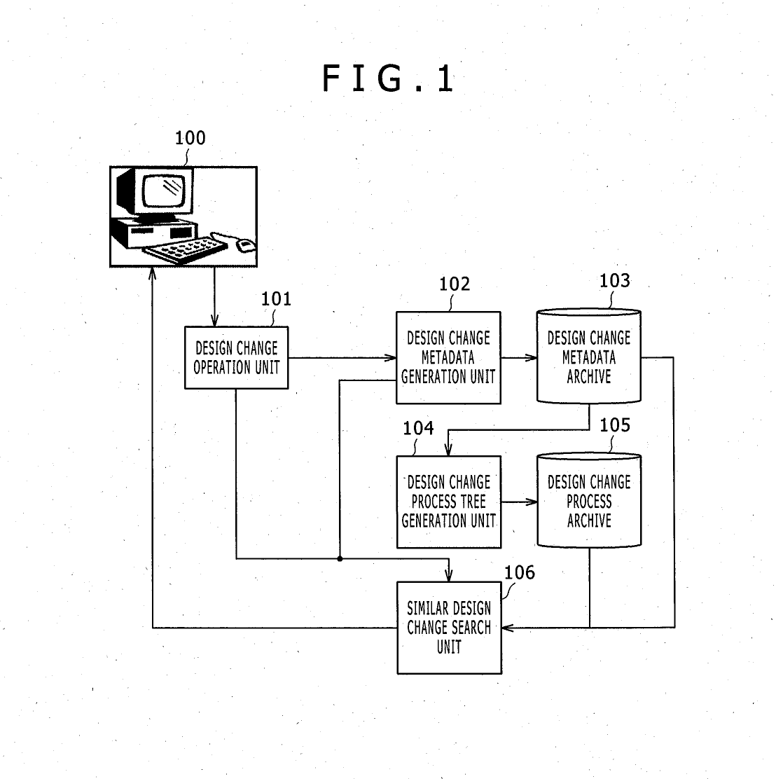

FIG. 1 is a block diagram showing a design change process management device as one embodiment of this invention. The design change process management device includes: an input/output device 100 made up of a keyboard, a pointing device, a display, etc., for allowing a device user to input and display data; a design change operation unit 101 for designating and working on a design change by use of a design support system such as a CAD system or a simulation system; a design change metadata generation unit 102 for extracting design parameters from design information such as CAD data and simulation data following a design change and for registering the design parameters as design change metadata in a design change metadata archive 103; a design change process tree generation unit 104 for generating design change process data from differences between the design change metadata generated when the user designated the design change through the design change operation unit 101 on the one hand and the existing design change metadata registered in the design change metadata archive 103 on the other hand, the design change process tree generation unit 104 further registering the design change process data in a design change process archive 105; and a similar design change search unit 106 for searching the design change process archive 105 for design change process data similar to the design change designated through the design change operation unit 101, the similar design change search unit 106 further displaying the searched-for design change process data on the input/output device 100.

Incidentally, the design change process management device may be implemented not only as a dedicated device but also in the form of a single computer or a computer system made up of a server and terminal devices connected to the server.

A typical procedure according to this invention is explained below.

(1) Design Change Metadata Generation Unit 102

The design change metadata generation unit 102 extracts design parameters from design information such as CAD data and simulation data following the design change and registers the design parameters as design change metadata in the design change metadata archive 103. In the case of CAD data, the design parameters may be dimensions such as distances and angles, the number of holes, and component types. In the case of simulation data, the design parameters may be materials, positions of constraint conditions, loads, stress, temperatures, and any other parameters that may be considered at a design stage. There are many other design parameters including material mixing ratios, temperatures and times of heat treatment, and cutting paths. These design parameters extracted from the CAD data and simulation data are used to generate design change metadata.

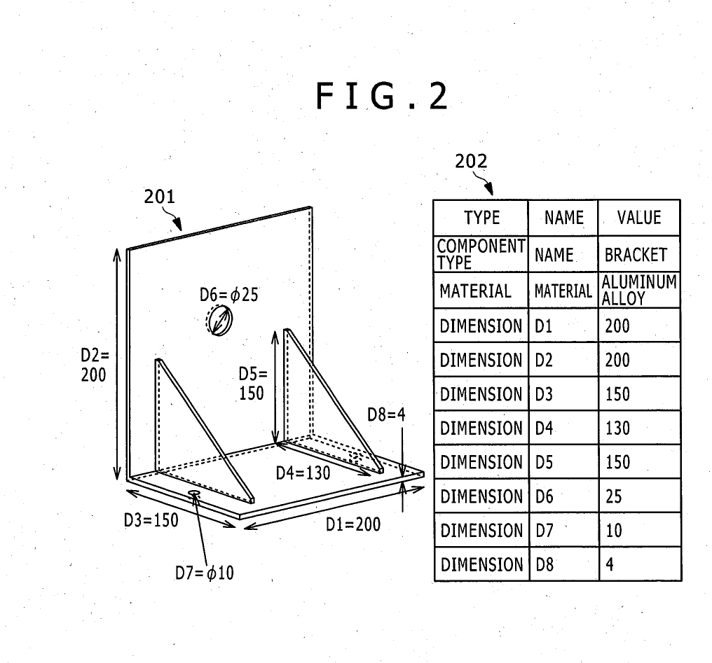

The data structure of design change metadata is managed with three variables: data types, data names, and values, for example. As the data types, the design parameter types such as dimensions, number of holes, constraint conditions, and stress are registered. As the data names, the identifiers such as the proper nouns of design parameters are registered. As the values, the settings of design parameters such as dimensions and stress values are registered. Whereas the wording “values” is used in this description for purpose of expression, the values are not limited to numerical values. For example, constraint condition “values” may be a vector indicative of the direction of the constraint, or shape element (plane, line, point, etc.) objects indicative of the constraint position. Also, material “values” may be a character string indicative of the name of the material or a set of material constant data such as Young's modulus, linear expansion coefficient, and mass density. A table 202 in FIG. 2 shows an example of design change metadata extracted from the CAD data indicated in an illustration 201 in the same figure. The design change metadata thus generated are registered in the design change metadata archive 103.

Whereas it is possible to generate design change metadata every time a design change operation is performed, the generation timing may also be at storage of design information or at any time designated by the user.

(2) Design Change Process Tree Generation Unit 104

The design change process tree generation unit 104 generates design change process data from differences between the design change metadata generated when the user designated a design change through the design change operation unit 101 on the one hand, and the existing design change metadata registered in the design change metadata archive 103 on the other hand, and registers the design change process data in the design change process archive 105. A design change process refers to the data indicative of a history of design changes in a tree structure. A typical procedure for preparing the design change process data is explained below.

### Step 1:

A search is made for design parameters changed between the design change metadata generated upon designation of a design change (called the design change metadata A hereunder) and the existing design change metadata registered in the design change metadata archive 103 (called the design change metadata B hereunder). In other words, the design change metadata A is compared with the design change metadata B so that the differences therebetween may be obtained as a result of the comparison. Here, three kinds of differences are searched for: design parameters not found in the design change metadata B and found in the design change metadata A (added parameters), design parameters found in the design change metadata B and not found in the design change metadata A (deleted parameters), and design parameters found in both the design change metadata A and the design change metadata B, with the parameter values changed (changed parameters). The design change metadata archive 103 is searched for design change metadata (called the design change metadata Z) having the smallest of these differences with the smallest time differential between the times at which the design change metadata were registered.

What follows is a detailed explanation of the differences. Before and after a design change, one of three processes is carried out: addition, deletion, or change of design parameters. Although multiple processes may conceivably be carried out simultaneously, it will be difficult to evaluate which of the processes has brought about the effects of the design change. For that reason, one process is performed in general. Thus if comparing the design change metadata A with the design change metadata B shows that there is no added or deleted design parameter but that there is a design parameter change, the relevant design change metadata B is extracted as the design change parameter Z having the smallest of the differences. At the next stage, comparing the design change metadata A with the design change metadata B may reveal that a design parameter has been added or deleted. In this case, the design change metadata B having the smallest time differential between the registration times of the design change metadata is extracted as the design change metadata Z having the smallest of the differences.

### Step 2:

The design change process archive 105 is searched for design change process data including the design change metadata Z.

### Step 3:

The design change metadata A is added as a child node of the design change metadata Z in the searched-for design change process data.

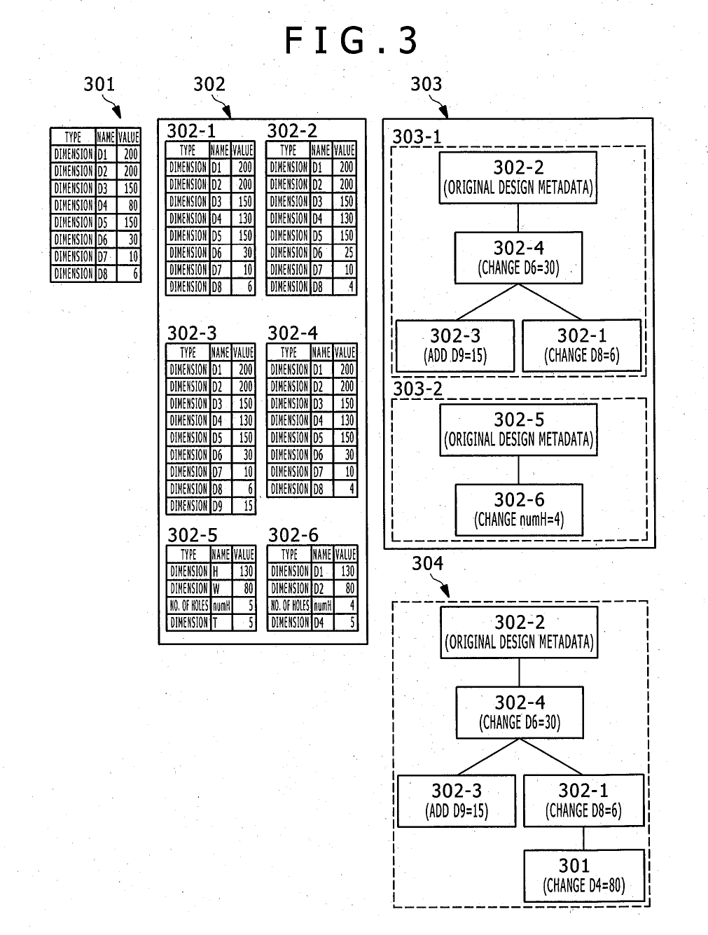

FIG. 3 shows how a design change process tree is typically generated. For this example, it is assumed that design change metadata 301 is generated upon designation of the design change and that a design change metadata archive 302 and a design change process archive 303 are provided. The design change metadata archive 302 is searched for the design change metadata having the smallest difference with regard to the design change metadata 301. As a result of the search, design change metadata 302-1 in which only the design parameter named “D4” (4th row) has its value changed is found. Because the design change metadata 302-1 is included in a design change process 303-1, the design change metadata 301 is added as a child node of the design change metadata 302-1 in the design change process 303-1. As a result, the design change process 303-1 is changed to a design change process 304.

(3) Similar Design Change Search Unit 106

The similar design change search unit 106 searches the design change process archive 105 for design change process data similar to the design change designated from the design change operation unit 101, and displays the searched-for design change process data on the input/output device 100. A procedure for searching for the similar design change process is explained below. A similar design change process refers to a design change process that includes the design change metadata Z having the smallest of the above-mentioned differences.

### Step 1, Step 2:

STEP 1 and STEP 2 are the same as those performed by the design change process tree generation unit 104 and thus will not be discussed further.

### Step 3:

The searched-for design change process data is displayed on the input/output device 100. An example of the search for a similar design change is explained here by use of the data shown in FIG. 3. The design change metadata archive 302 is searched for the design change metadata having the smallest difference with regard to the design change metadata 301. As a result of the search, design change metadata 302-1 in which only the design parameter named “D4” has its value changed is found. Because the design change metadata 302-1 is included in the design change process 303-1, the design change process 303-1 matches the search. This design change process 303-1 is displayed on the input/output device 100.

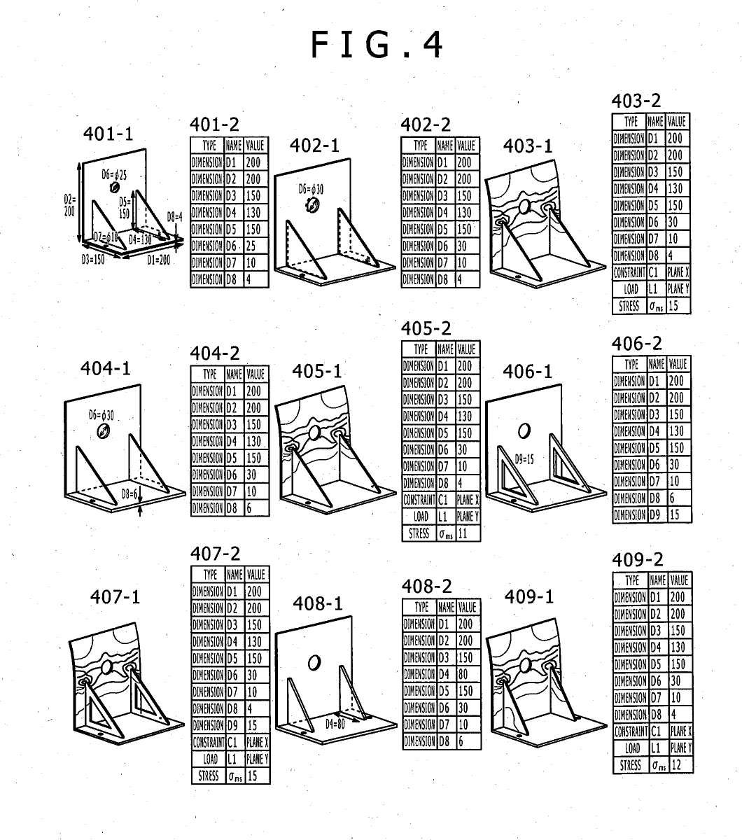

Explained below with reference to FIG. 4 is a specific example of design changes together with the operation of this design change process management device. It is assumed that data 401-1 is provided as the original CAD data in effect before a design change. Design change metadata 401 is changed to design change metadata 401-2. The ensuing explanation is based on the assumption that the original CAD data is changed in design so that a shaft with a diameter of 30 mm will be passed through a center hole.

First, the user simply changes a dimension D6 to 30 through the design change operation unit 101 (402-1). At this point, the design change metadata generation unit 102 generates design change metadata indicated by reference numeral 402-2 and registers the generated metadata 402-2 in the design change metadata archive 103.

Next, the user performs stress analysis (403-1). In this example, the constraint condition, load condition, and a maximum value of von Mises equivalent stress in effect when the stress analysis was carried out are assumed to be registered as design change metadata. As a result, this device generates design change metadata indicated by reference numeral 403-2.

Upon verifying the result of the analysis, the user finds that stress is not within the margin of safety, and proceeds to consider improving stiffness. The user then changes a dimension D8 (plate thickness) from 4 mm to 6 mm (404-1). As a result, this device generates design change metadata indicated by reference numeral 404-2. Subsequently, the user performs stress analysis in the same manner as before (405-1), so that design change metadata indicated by reference numeral 403-2 is generated.

Upon verifying the result of this analysis, the user finds that stress is within the margin of safety but that weight increased and cost is raised. The user thus adds a cut (dimension D9) to a rib part (406-1). As a result, this device generates design change metadata indicated by reference numeral 406-2.

Subsequently, stress analysis is performed likewise (407-1), so that design change metadata indicated by reference numeral 407-2 is generated. Upon verifying the result of this analysis, the user finds that weight is reduced too much to put stress outside the margin of safety, and proceeds to change the dimension of a rib leg (D4) from 130 mm to 80 mm (408-1). As a result, this device generates design change metadata indicated by reference numeral 408-2. Subsequently, stress analysis is performed likewise (409-1), so that design change metadata indicated by reference numeral 409-2 is generated. Upon verifying the result of this analysis, the user finds that both stress and weight (cost) are acceptable.

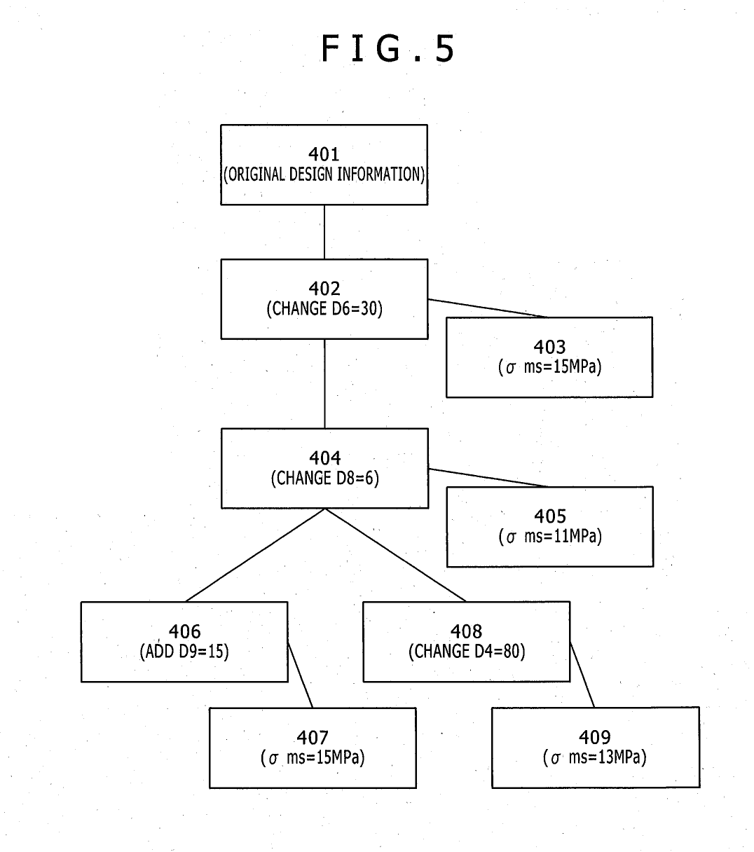

After generating design change metadata at each of the subsequent design changes, the design change process tree generation unit 104 generates design change process data accordingly. The final design change process data takes on a tree structure such as one shown in FIG. 5.

Next, suppose that, with the above design change metadata archive and design change process data archive already registered, another user makes a design change such that a shaft with a diameter of 28 mm will be passed through the center hole. This user simply changes the dimension D6 to 28 through the design change operation unit 101. At this point, this device generates design change metadata and causes the similar design change search unit 106 to search for a design change process similar to the design change metadata. The design change metadata indicated by reference numeral 402-1 is found to have the smallest difference, so that the design change process data including the design change metadata 402-1 and shown in FIG. 5 is searched for. The similar design change search unit 106 proceeds to display on the input/output device 100 the design change process data shown in FIG. 5. Whereas this example shows as the design change process data only the information about the differences between design change metadata at parent and child nodes, it is also possible to display a screen shot of the system screen in effect upon design change with various design support systems (e.g., CAD system and simulation system). In such cases, screen shots as design parameters may preferably be registered as design change metadata.

By looking at the design change process data, the user will, for example, notice the following:

Changing the dimension D6 lowers stiffness.

In the past, a dimension D4 was changed to improve stiffness.

The rib is cut and the rib leg length is changed so as to reduce weight.

Stress can be lowered preferably by changing the rib leg length.

As a result, the user may come up with a design proposal based on the past design change results and avoid needlessly considering yet again the design proposals discarded in the past.

As explained above, the design change process management device can accumulate and manage design change process results and the bases for the design changes involved. The design change process management device can also search the accumulated design change processes for a similar design change process and display the searched-for design change process.

### DESCRIPTION OF REFERENCE CHARACTERS

100 Input/output device
101 Design change operation unit
102 Design change metadata generation unit
103 Design change metadata archive
104 Design change process tree generation unit
105 Design change process archive
106 Similar design change search unit

1. A design change process management device comprising:
a design change metadata generation unit that extracts design parameters from design information such as CAD data and simulation data and registers the extracted design parameters as first design change metadata;
a design change metadata archive in which the first design change metadata is registered;
a design change process generation unit that generates first design change process data from differences between the registered first design change metadata and second design change metadata already registered in the design change metadata archive;
a design change process archive in which the generated first design change process data is registered; and
a similar design change search unit that searches the design change process archive for second design change process data similar to a design change designated by an operator, the similar design change search unit further displaying the searched-for second design change process data on an input/output device.

2. The design change process management device according to claim 1, wherein the first design change metadata at least includes a data type, a data name, and a value.

3. The design change process management device according to claim 1, wherein the design change process generation unit compares the first design change metadata with the existing second design change metadata registered in the design change metadata archive, searches the second design change metadata for existing third design change metadata having the smallest of the differences resulting from the comparison, searches the design change process archive for third design change process data including the third design change metadata, and adds the first design change metadata as a child node of the third design change metadata in the searched-for third design change process data.

4. The design change process management device according to claim 1, wherein the similar design change search unit compares the first design change metadata with the existing second design change metadata registered in the design change metadata archive, searches the second design change metadata for third design change metadata having the smallest of the differences resulting from the comparison, searches the design change process archive for third design change process data including the third design change metadata, and displays the searched-for third design change process data on the input/output device.

5. A design change process management method for a design change process management device furnished with a design change metadata archive in which to register design change metadata, a design change process archive in which to register design change process data, and an input/output device, the design change process management method causing the design change process management device to perform:
extracting design parameters from design information such as CAD data and simulation data;
registering the extracted design parameters as first design change metadata in the design change metadata archive;
generating first design change process data from differences between the registered first design change metadata and existing second design change metadata registered in the design change metadata archive;
registering the generated first design change process data in the design change process archive;
searching the design change process archive for second design change process data similar to a design change designated by an operator; and
displaying the searched-for second design change process data on the input/output device.

6. The design change process management method according to claim 5, wherein the first design change metadata at least includes a data type, a data name, and a value.

7. The design change process management method according to claim 5, wherein the design change process generation unit is caused to compare the first design change metadata with the existing second design change metadata registered in the design change metadata archive, search the second design change metadata for third design change metadata having the smallest of the differences resulting from the comparison, search the design change process archive for third design change process data including the third design change metadata, and add the first design change metadata as a child node of the third design change metadata in the searched-for third design change process data.

8. The design change process management method according to claim 5, wherein the design change process management device is caused to compare the first design change metadata with the second design change metadata registered in the design change metadata archive, search for third design change metadata having the smallest of the differences resulting from the comparison, search the design change process archive for third design change process data including the third design change metadata, and display the searched-for third design change process data on the input/output device.
